(19) United States
(12) Patent Application Publication
(10) Pub. No.: US 2024/0378528 A1
(43) Pub. Date: Nov. 14, 2024

(54) Automated Extraction, Clustering, and Sequencing of Actions Occurring on a Computing Device or Network

(71) Applicant: ServiceNow, Inc., Santa Clara, CA (US)

(72) Inventors: Bruce Walthers, Santa Clara, CA (US); Dinesh Kumar Kishorkumar Surapaneni, Chicago, IL (US); Jeevan Anand Anne, Hyderabad (IN); Abhay Kulkarni, Santa Clara, CA (US); Sheeba Srinivasan, Atlanta, GA (US)

(21) Appl. No.: 18/196,346

(22) Filed: May 11, 2023

Related U.S. Application Data
(63) Continuation of application No. 17/197,785, filed on Mar. 10, 2021, now abandoned.

(51) Int. Cl. G06F 16/35; H04L 41/069

(52) U.S. Cl. CPC G06Q 10/0633; G06F 16/35; G06Q 10/06316

(57) ABSTRACT

An example embodiment includes determining, from a set of entries stored in a memory, a set of performed actions; identifying clusters of similar actions within the set of performed actions based on multidimensional vector embeddings of the performed actions, wherein each of the performed actions is a member of one of the clusters, and wherein each of the clusters contains at least one of the performed actions; determining a sequence for the clusters based on orderings of the performed actions within the set of entries and the membership of the performed actions within the clusters; and providing for display, on a user interface, representations of the performed actions within the clusters, wherein the representations of the performed actions are ordered according to the determined sequence for the clusters.

### CROSS-REFERENCE TO RELATED APPLICATION

This application is a continuation of and claims priority to U.S. patent application Ser. No. 17/197,785, filed Mar. 10, 2021, which is hereby incorporated by reference in its entirety.

### BACKGROUND

When a user of an information network or other technological system experiences and/or solves a problem, the problem has likely occurred before. In a managed network, records of such problems may be kept in order to track and organize their resolution, to facilitate operation of technical aspects of an organization, to inform technology upgrades, or to provide some other benefit. Accordingly, such records may contain useful information relevant to the resolution of the user's current problem.

### SUMMARY

A large set of incident reports, generated as part of the management of an information technology infrastructure system, contains a great deal of useful information about the operation of the information technology infrastructure system. This information includes data about the existence of discrete reoccurring problems with the operation of the system and/or with users' experiences interacting with the system. Thus, it can be worthwhile to mine the set of incident reports for information about the existence, prevalence, and solution of problems related to the operation of the system.

A set of incident reports related to a common problem may contain information about steps that are useful in troubleshooting and/or rectifying the common problem. An automated method, provided herein, may be employed to quickly and effectively extract a sequence of steps (also referred to as a ‘playbook’) from a corpus of incident reports. The extracted playbooks could then be provided to technicians to inform future resolution of common problems, translated into knowledgebase articles, used to program automated dialog trees, used to develop semi-automated workflows, or used to provide some other benefit related to the management of an information technology infrastructure system.

Such an automated playbook generation process can include a number of steps. A first step can include selecting, from a corpus of incident reports, a target set of incident reports from which to generate a playbook. Such a selection step may include identifying a set of incident reports that are related to a common problem. This could include determining a similarity between the incident reports of the corpus and/or between the incident reports and a target string (e.g., a description of a known common problem) and selecting the set of incident reports based on the similarity values (e.g., selecting the top n incident reports with respect to the similarity value). Such a selection step may additionally or alternatively include identifying a set of incident reports that are likely to have contents that are be useful in generating steps for a playbook, e.g., selecting incident reports that are longer, that include more action verbs, that include numbered lists, etc.

Once a set of incident reports have been selected, potential playbook steps, or fragments thereof, could be identified within the incident reports. This can include identifying fragments within the incident reports (e.g., sentences, phrases, clauses). The fragments can then be filtered according to the likelihood that they contain information that is relevant to a playbook step. For example, the fragments could be scored and fragments having scores above a threshold level could be retained. Such scoring could include determining whether the fragment contains action verbs, whether the fragment represents boilerplate language (e.g., personal introductions), etc. The retained fragments could then be used to determine a set of playbook steps, e.g., by performing a clustering process on the fragments. Each playbook step includes at least one of the fragments. Each playbook step may be represented by fragment(s) in fewer than all of the source incident reports. Further, each playbook step may be represented by more than one fragment in a single incident report. A sequence for the identified playbook steps can then be determined.

The ordered playbook steps can then be presented to a human user. The user can then modify the steps, re-order the steps, use the playbook to generate an automated dialog tree or knowledgebase article, or otherwise modify or use the playbook in some other way. In some examples, a process of playbook filtering could occur prior to presenting a playbook to a human user, so as to reduce user time spent on poor-quality playbooks. Such a playbook filtering process can include determining metrics related to the distribution of playbook steps across the source incident reports.

Accordingly, a first example embodiment may involve a computer-implemented method including: (i) determining, from a target set of incident reports, a set of putative steps, wherein each incident report of the target set of incident reports includes at least one putative step from the set of putative steps; (ii) determining a set of playbook steps by identifying a set of clusters within the set of putative steps, wherein each playbook step of the set of playbook steps corresponds to a respective cluster within the identified set of clusters, and wherein each cluster within the identified set of clusters contains at least one putative step of the set of putative steps; (iii) determining a sequence for the set of playbook steps based on an ordering of the putative steps within the target set of incident reports and the correspondences between the putative steps and the identified set of clusters; and (iv) displaying, on a user interface, an indication of the set of playbook steps according to the determined sequence for the set of playbook steps.

A second example embodiment may involve a computational instance of a remote network management platform including: (i) a database containing a plurality of incident reports, wherein the incident reports include text-based fields that document technology-related problems experienced by users of a managed network; and (ii) one or more processors configured to: (a) determine, from a target set of incident reports contained within the database, a set of putative steps, wherein each incident report of the target set of incident reports includes at least one putative step from the set of putative steps; (b) determine a set of playbook steps by identifying a set of clusters within the set of putative steps, wherein each playbook step of the set of playbook steps corresponds to a respective cluster within the identified set of clusters, and wherein each cluster within the identified set of clusters contains at least one putative step of the set of putative steps; (c) determine a sequence for the set of playbook steps based on an ordering of the putative steps within the target set of incident reports and the correspondences between the putative steps and the identified set of clusters; and (d) display, on a user interface, an indication of the set of playbook steps according to the determined sequence for the set of playbook steps.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 depicts a multi-phase incident report filtering process, in accordance with example embodiments.

FIG. 7A depicts phases of processing an incident report to extract playbook steps therefrom, in accordance with example embodiments.

FIG. 7B depicts elements of multiple incident reports and playbook steps extracted therefrom, in accordance with example embodiments.

FIG. 7C depicts elements of a user interface, in accordance with example embodiments.

FIG. 8 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. EXAMPLE COMPUTING DEVICES AND CLOUD-BASED COMPUTING ENVIRONMENTS

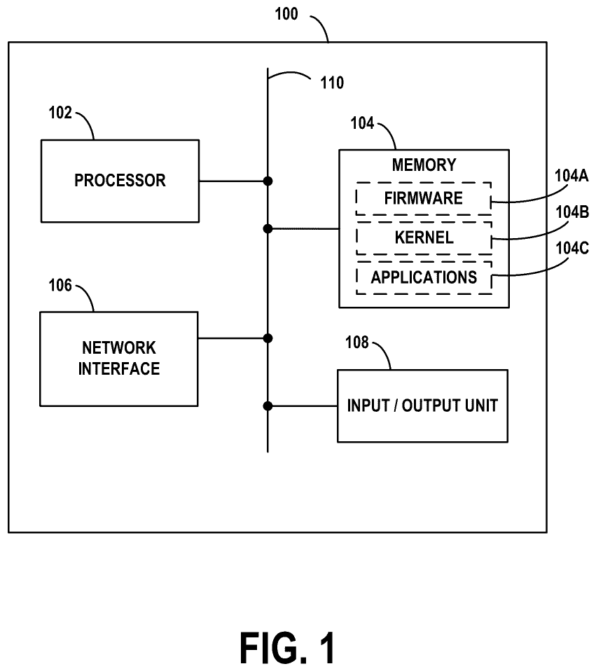

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

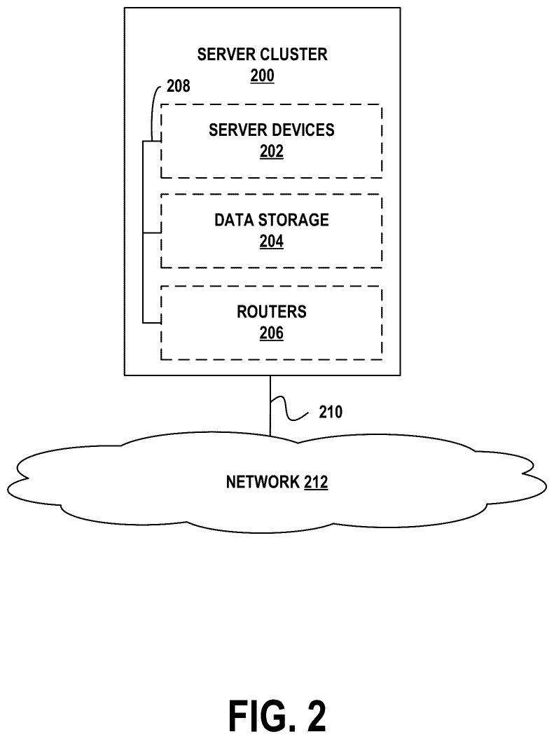

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PUP Hypertext Preprocessor (PUP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. EXAMPLE REMOTE NETWORK MANAGEMENT ARCHITECTURE

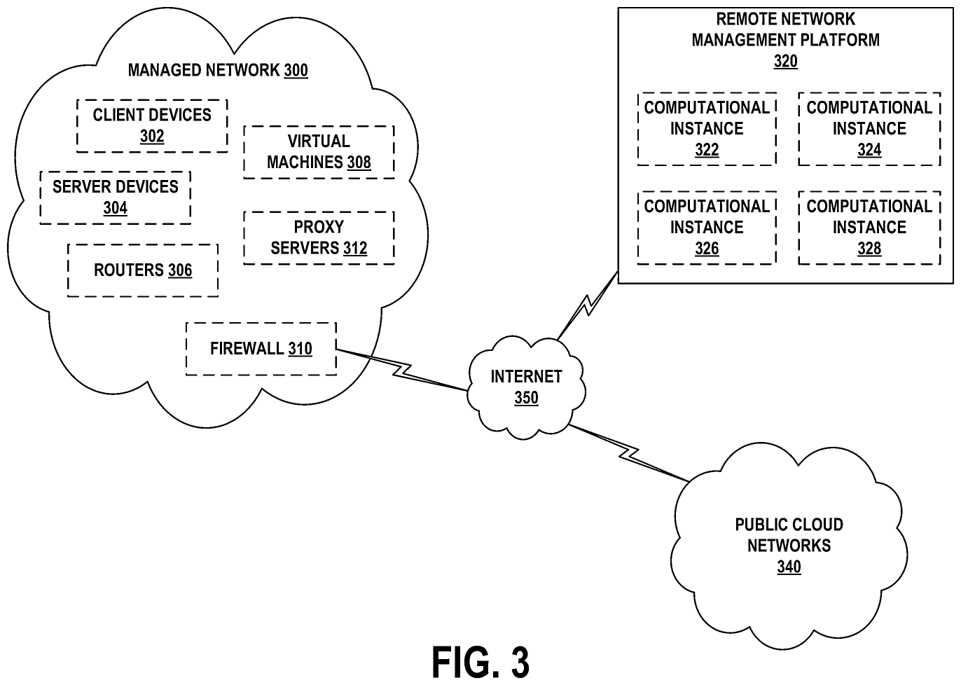

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

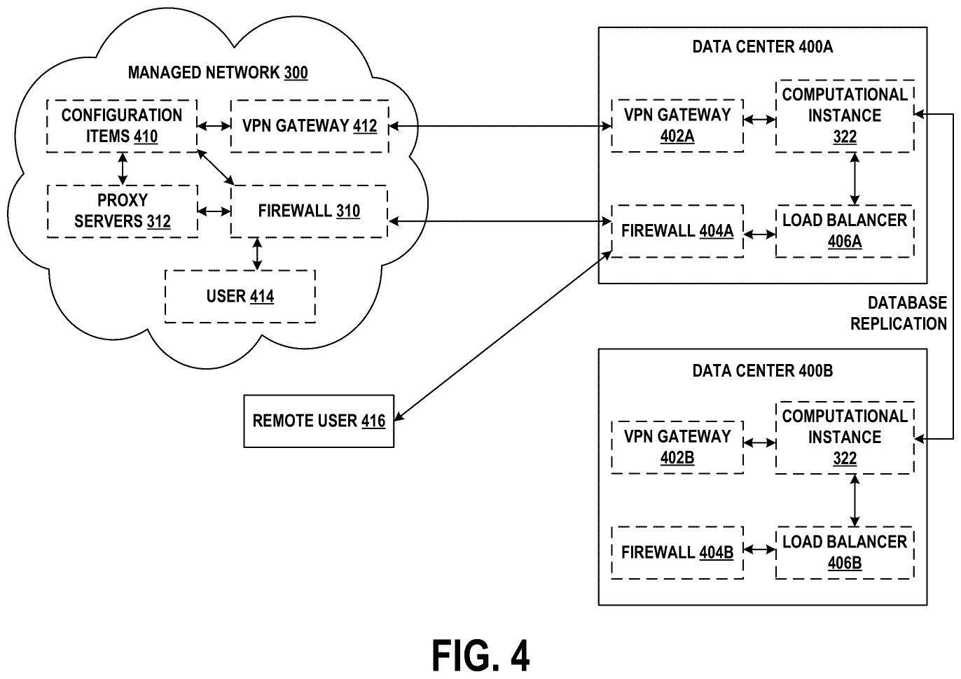

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. EXAMPLE DEVICE, APPLICATION, AND SERVICE DISCOVERY

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

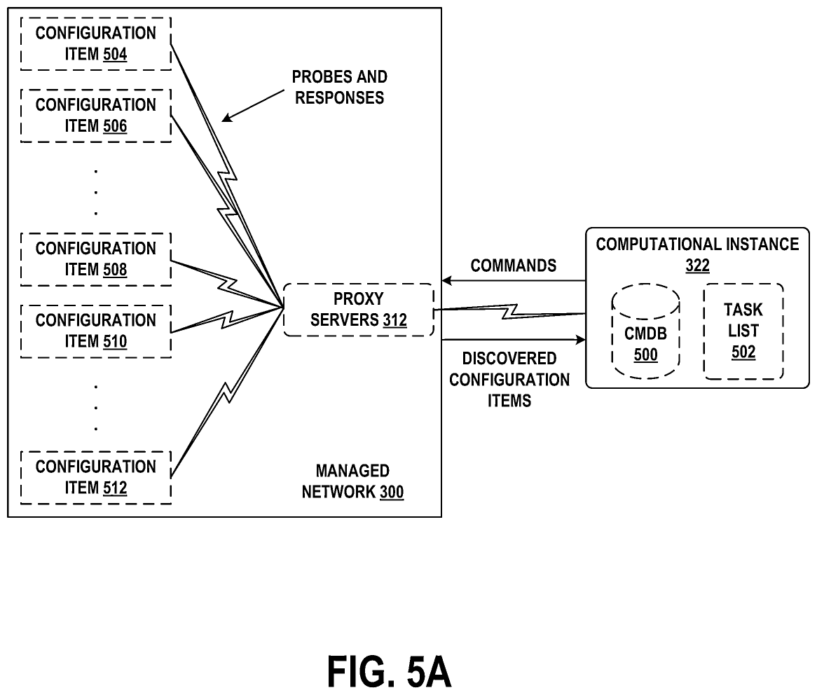

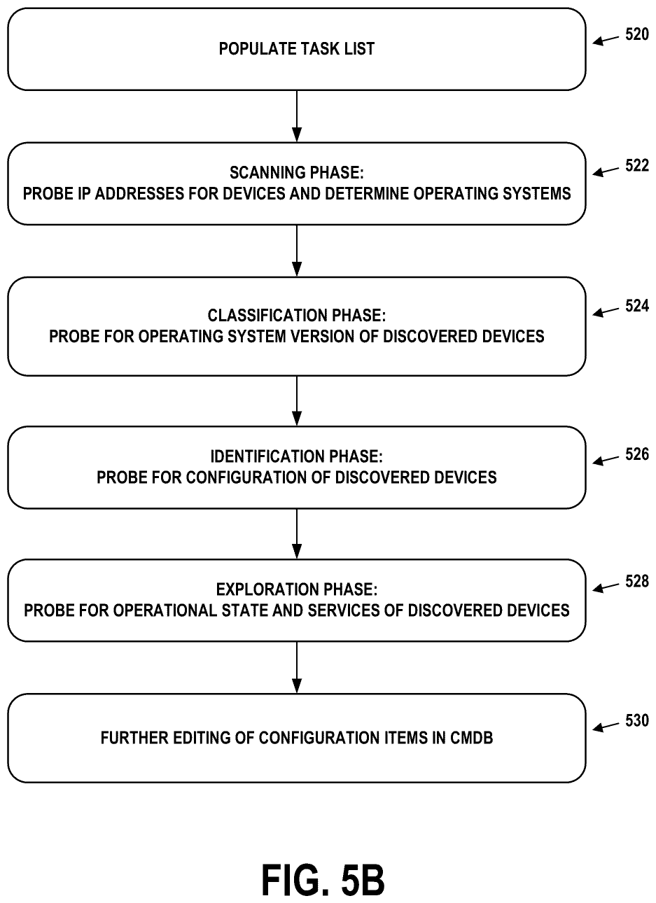

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. EXAMPLE MODELS FOR NATURAL LANGUAGE PROCESSING AND CLUSTERING

Machine learning (ML) models may utilize the classification, similarity, and/or clustering techniques described below to facilitate the automated generation of playbooks. But other ML-based techniques may be used. Further, there can be overlap between the functionality of these techniques (e.g., clustering techniques can be used for classification or similarity operations).

ML techniques can include determining word and/or paragraph vectors from samples of text by artificial neural networks (ANNs), other deep learning algorithms, and/or sentiment analysis. These techniques are used to determine a similarity between samples of text, to group multiple samples of text together according to topic or content, to partition a sample of text into discrete internally-related segments, to determine statistical associations between words, or to perform some other language processing task.

A word vector may be determined for each word present in a corpus of textual records such that words having similar meanings (or semantic content) are associated with word vectors that are near each other within a semantically encoded vector space. Such vectors may have dozens, hundreds, or more elements and thus may be an m-space where m is a number of dimensions. These word vectors allow the underlying meaning of words to be compared or otherwise operated on by a computing device (e.g., by determining a distance, a cosine similarity, or some other measure of similarity between the word vectors). Accordingly, the use of word vectors may allow for a significant improvement over simpler word list or word matrix methods. Thus, these models have the benefit of being adapted to the vocabulary, topics, and idiomatic word use common in its intended application.

Additionally or alternatively, the word vectors may be provided as input to an ANN, a support vector machine, a decision tree, or some other machine learning algorithm in order to perform sentiment analysis, to classify or cluster samples of text, to determine a level of similarity between samples of text, or to perform some other language processing task.

Despite the usefulness of word vectors, the complete semantic meaning of a sentence or other passage (e.g., a phrase, several sentences, a paragraph, a text segment within a larger sample of text, or a document) cannot always be captured from the individual word vectors of a sentence (e.g., by applying vector algebra). Word vectors can represent the semantic content of individual words and may be trained using short context windows. Thus, the semantic content of word order and any information outside the short context window is lost when operating based only on word vectors.

Similar to the methods above for learning word vectors, an ANN or other ML models may be trained using a large number of paragraphs in a corpus to determine the contextual meaning of entire paragraphs, sentences, phrases, or other multi-word text samples as well as to determine the meaning of the individual words that make up the paragraphs in the corpus. For example, for each paragraph in a corpus, an ANN can be trained with fixed-length contexts generated from moving a sliding window over the paragraph. Thus, a given paragraph vector is shared across all training contexts created from its source paragraph, but not across training contexts created from other paragraphs.

Word vectors and paragraph vectors are two approaches for training an ANN model to represent the sematic meanings of words. Variants of these techniques, e.g., using continuous bag of words, skip-gram, paragraph vector—distributed memory, paragraph vector—distributed bag of words, may also be used. Additionally or alternatively, other techniques, such as bidirectional encoder representations from transformers (BERT), may be used for example. These techniques may be combined with one another or with other techniques.

As an example relevant to the embodiment herein, vector models can be trained using word vector or paragraph vector techniques. To that point, a trained vector model may take input text from a record (e.g., representing an incident) and produce a vector representation of the record. This vector representation encodes the sematic meaning of the input text by projecting the input text into m-dimensional space. Similar units of input text will likely have similarly-located vector representations in the m-dimensional space.

Accordingly, a similarity model may take an input vector representation of a record and produce zero or more similar records. As noted above, the degree of similarity between two units of input text can be determined by calculating a similarity measurement between their respective vector representations. One such measurement may be based on cosine similarity, which is defined by the following equations:

$$similarity ( \vec{A} , \vec{B} ) = \frac{\vec{A} \cdot \vec{B}}{‖ \vec{A} ‖ ‖ \vec{B} ‖} \\ where ‖ \vec{A} ‖ = \sqrt{{A}_{1}^{2} + {A}_{2}^{2} + {A}_{3}^{2} + … + {A}_{m}^{2}} , and \\ ‖ \vec{B} ‖ = \sqrt{{B}_{1}^{2} + {B}_{2}^{2} + {B}_{3}^{2} + … + {B}_{m}^{2}}$$

In these equations, vector A could represent one input vector and vector B could represent another input vector, one of which could be derived from a new incident solution and the other from a previously stored incident solution, for example. Vector A and vector B could both be of dimension m. The similarity calculation may have an output a number between −1 and +1, where the closer this result is to +1, the more similar vectors A and B are to each other.

Thus, the similar records produced by the similarity model may be those with vector representations for which the respective cosine similarities with the input vector representation of the record are above a threshold value. Alternatively, the output of similar records may be a certain number of input texts (or identifiers for the certain number of input texts) for which the respective cosine similarities with the input vector representation of the record are the most similar.

The similarity calculations described above may also be used to cluster similar records or similar portions of a single record and/or of multiple records. Such clustering may be performed to provide a variety of benefits. For example, clustering may be applied to a set of records in order to identify patterns or groups within the set of records that have relevance to the operation of a system or organization. In another example, clustering may be applied to sentences, clauses, or other segments within one or more records in order to identify patterns or groups within the set of records that have relevance to the operation of a system or organization, e.g., that may be related to a discrete step or other element of a process for resolving a common problem or for performing some other action.

Clustering may be performed in an unsupervised manner in order to generate clusters without the requirement of manually-labeled records, to identify previously unidentified clusters within the records, or to provide some other benefit. A variety of methods and/or ML, algorithms could be applied to identify clusters within a set of records and/or to assign records (e.g., newly received or generated records) to already-identified clusters. For example, decision trees, ANNs, k-means, support vector machines, independent component analysis, principal component analysis, a self-organizing map, or some other method could be trained based on a set of available records in order to generate an ML model to classify the available records and/or to classify records not present in the training set of available records.

For instance, leveraging the vector representations described herein, records can be clustered based on the semantic meanings of their constituent text. Clusters may be identified, for example, to include vector representations that are within a particular extent of similarity from one another, or not more than a particular Euclidian distance from a centroid in m-space. In these models, some outlying vector representations may remain unclustered.

Once an ML model for clustering has been determined, the ML model can be applied to assign additional records to the identified clusters represented by the ML model and/or to assign records to a set of residual records. The ML model could include parameter values, neural network hyperparameters, cluster centroid locations in feature space, cluster boundary locations in feature space, threshold similarity values, or other information used, by the ML model, to determine which cluster to assign a record and/or to determine that the record should not be assigned to a cluster (e.g., should be stored in a set of residual, unassigned records). Such information could define a region, within a feature space, that corresponds to each cluster. That is, the information in the ML model could be such that the ML model assigns a record to a particular cluster if the features of the record correspond to a location, within the feature space, that is inside the defined region for the particular cluster. The defined regions could be closed (being fully enclosed by a boundary) or open (having one or more boundaries but extending infinitely outward in one or more directions in the feature space)

### VI. EXAMPLE PLAYBOOK GENERATION

A database of incident reports or other records related to the operation and management of a managed network can include a wealth of information about problems or events that commonly occur, as well as information about actions that successfully resolved or improved those problems. This information can take the form of ordered lists of steps, individual phrases/sentences/paragraphs interspersed throughout an incident report, or other forms. Embodiments provided herein facilitate the operation of a managed network or other information technology system by identifying such ‘solution information’ within a corpus of incident reports or other records and distilling the identified information into an ordered list of steps. These steps can then be used to facilitate the resolution of related problem(s), e.g., by providing a ‘playbook’ that a human technician could follow in diagnosing and resolving future occurrences of the related problem.

Such a playbook generation process could include pre-filtering the corpus of incident reports. This could include identifying and extracting playbook information only from a group of similar incident reports (e.g., from incident reports that are related to a particular issue or problem) and/or only from incident reports that are especially likely to contain useful problem resolution information.

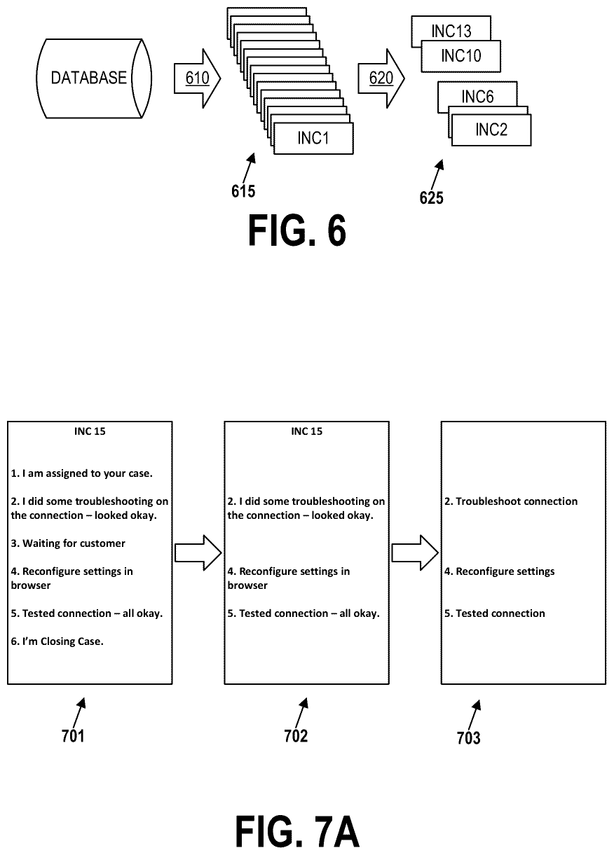

Such an incident reporting filtering process is illustrated by way of example in FIG. 6. A database contains a plurality of incident reports related to a managed network (e.g., managed network 300) or to some other information technology system. A first filter 610 acts to identify a first set of incident reports 615 that are related to each other and/or to a specified problem or event or that are otherwise similar. A second filter 620 then identifies, within the first set of incident reports 615, a second set of incident reports 625 that are likely to contain useful problem-resolution information (e.g., due to containing action words, due to being greater than a specified size, etc.). This second set of incident reports 625 can then be analyzed to generate a playbook.

Note that a playbook generation process as described herein could omit either of the filtering processes 610, 620 (e.g., due to the set of incident reports having being previously identified) and/or the ordering of the filtering processes 610, 620. For example, filtering the incident reports for likelihood to contain useful problem-resolution information could be performed as the incident reports are generated (e.g., a ‘usefulness’ flag could be set by the user or automatically and stored in the database in a record with the rest of the incident report information). In embodiments wherein the second filtering process 620 is performed first, the first filtering process 610 could be performed based on information in incident reports that were not selected by the second filtering process 620. This could be done in order to allow a clustering algorithm, search algorithm, or other process used as part of the first filtering process 610 to be informed by information in incident reports that are unlikely to contain useful problem-resolution information but that may contain other information relevant to incident report clustering, query searching, or other processes relevant to the first filtering process 610.

Identifying the first set of incident reports 615 that are similar to each other can include a variety of processes. In some examples, a similarity metric could be determined for each of the incident reports and the group of similar incident reports determined based on the similarity scores. For example, the n incident reports with the highest similarity scores could be selected, with n being a specified number of incident reports (e.g., 5, 10, 15). The similarity score could be a measure of similarity between each incident report and a search query, a selected incident report of interest, or some other specified target. The similarity metric could be determined based on paragraph vectors or other representations of the semantic content of the incident reports. For example, the similarity metric could be a distance, within a multi-dimensional semantic space, between paragraph vectors for the incident reports and a target location in the multi-dimensional semantic space (e.g., a location of a paragraph vector of an exemplar incident report, a location of a paragraph vectors of a search query).

Additionally or alternatively, identifying the first set of incident reports 615 can include applying a clustering algorithm to incident reports in the database so as to identify related incident reports that may, in turn, be related to a single type of problem or event for which a playbook may be useful. Such clustering could be performed based on the semantic content of the incident reports. For example, one or more paragraph vectors could be determined for each of the incident reports and/or for specific contents of the incident reports. The incident reports could be clustered based on the similarity of their paragraph vectors and/or other factors (e.g., user identity, technician identity, date stamp, user location, user department, etc.).

Identifying the second set of incident reports 625 that are likely to contain useful problem-resolution information can include a variety of processes. This can include determining a “step extraction score” for each incident report that represents the likelihood that an incident report contains useful problem-resolution information. Once determined, the step extraction score for a particular incident report could be compared to a threshold value in order to determine whether to attempt to extract playbook step information from the particular incident report. Determining a step extraction score for an incident report can include determining one or more properties of the incident report and then determining the step extraction score from the properties (e.g., as a linear combination of a number of numerical properties). Such properties can include a number of action verbs in the incident report, whether the incident report contains a configuration item or artifact, whether the incident report contains a list, the total number of words in the incident report and/or in one or more sub-sections of the incident report (e.g., a “problem diagnosis” or “work performed” sub-section of the incident report), and/or some other property. Each of these properties increases the score because it is likely to represent information relevant to a potential resolution of the related incident.

A configuration item or artifact is any text string, hyperlink, or other incident report content that leads to or otherwise refers to a specific item or object that is part of or related to a managed network (e.g., a configuration item or other object referenced in CDMB 500). A configuration item or artifact can include an identifier that refers to a knowledgebase article (e.g., a string “KB00027185” and/or descriptive text that references a knowledgebase article and that contains a hyperlink thereto), a specific piece of software and/or version or configuration thereof, a specific piece of hardware and/or version or configuration thereof, an identifier that refers to a user (e.g., a string “USR0001234” and/or a hyperlink to a database entry containing information about a user), an identifier that refers to a client, an identifier that refers to a project, an identifier that refers to a specific incident report or other database record, or some other identifying string or link that refers to a specific object, person, or topic related to a managed network.

Once the set of incident reports have been selected (e.g., by the methods described above and/or by some other method), putative playbook steps can be identified within the selected incident reports and extracted from the incident reports for sequencing, summarization, or other processes. The sets of putative steps from a number of incident reports can then be used to determine a set of playbook steps for a playbook. This can include clustering the combined putative steps across a number of different incident reports to identify, within the set of putative steps, sub-sets of putative steps that correspond to respective playbook steps. A sequence for the determined playbook steps can then be determined based on the ordering, within the incident reports, of the putative steps and their pattern of correspondence to the playbook steps.

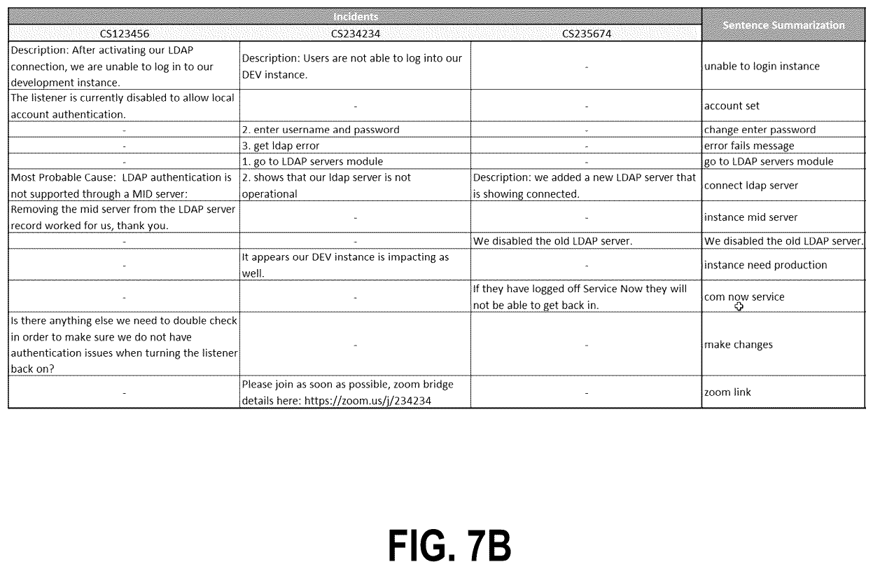

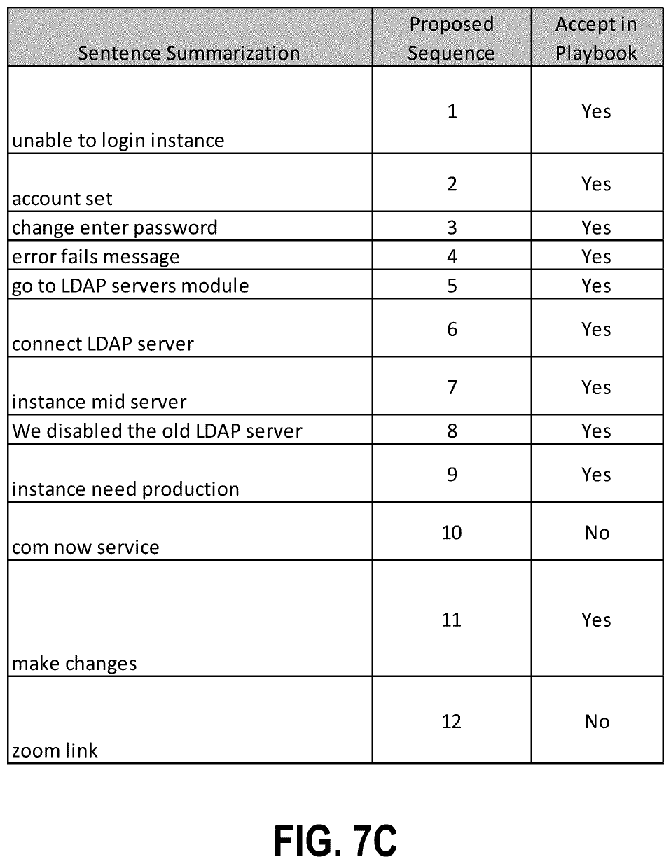

Identifying putative steps from an incident report can include separating the incident report into non-overlapping segments, which may each represent all or part of a putative playbook step, and then filtering out those segments that are unlikely to contain useful problem-resolution information. Elements of such a process are illustrated in FIG. 7A for an example incident report “INC 15.” A first pane 701 shows the incident report with its contents separated into a number of non-overlapping segments. These segments have been numbered for purposes of illustration in FIG. 7A. A second pane 702 shows the non-overlapping segments with some of the segments that are unlikely to contain useful problem-resolution information filtered out; the remaining segments are the putative steps determined for the incident report. So, for example, segments that contain pleasantries (“I am assigned to your case”), boilerplate phrases (“Closing Case”), or other less-useful information have been filtered out. Finally, playbook steps can be determined from the filtered putative steps (e.g., by clustering putative steps from multiple different incident reports or by some other method as described elsewhere herein). Summary phrases can then be determined for each of the putative steps. This is illustrated in a third pane 703. As shown, each putative step of “INC 15” corresponds to a single respective different playbook step. However, this is only true in FIG. 7A for the purposes of illustration. In practice, multiple putative steps, which may be non-contiguous, from a single incident report may correspond to a single identified playbook step.

Identifying sets of non-overlapping segments within an incident report can include a variety of processes by which the content of the incident report is partitioned into the non-overlapping segments. For example, the contents of the incident report could be partitioned according to the section breaks or other structure within the incident report. Periods, semicolons, or other punctuation within the incident report could be used to partition the incident report (e.g., such that periods or other ending punctuation is placed at ends of segments). Natural language processing or other techniques could be applied to partition the incident report into separate sentences, phrases, or clauses. Bulleted or numbered lists could be detected within the incident report and the incident report partitioned such that each element of the list(s) corresponds to a respective different segment (or set of segments, e.g., if a list element contains multiple sentences, clauses, etc.).

Filtering the identified non-overlapping segments to determine a set of putative steps can include determining, for each identified segment, a score that is related to the likelihood that the segment contains useful problem-resolution information. This score could then be compared to a specified threshold in order to determine whether the segment should be retained and used to determine the set of putative steps for an incident report. Determining such a score for a segment can include determining one or more properties of the segment and then determining the score from the properties (e.g., as a linear combination of a number of numerical properties). Such properties can include whether a segment contains an action verb, a number of action verbs in a segment, whether a segment contains a configuration item or artifact, whether a segment contains a list, whether a segment contains a question, whether a segment represents boilerplate content (e.g., the segment contains “hello,” “goodbye,” a string matching a legal disclaimer, etc.), whether a segment contains a URL, a number of words in a segment, whether a segment contains words indicative of proposing a solution (e.g., “tried,” “reconfigured,” “reset,” “rebooted,” “configured,” “trying”), or whether a segment contains or ends with a colon. Additionally or alternatively, segments could be retained or discarded based on whether they match one or more specified criteria. This could include determining whether a segment contains one or more tags that correspond to a specified set of one or more reject tags such as a “requestor_comment” tag. Such a reject tag could include a tag or other indication that the segment is part of user comment, since user comments are not generated by technicians and so are not likely to contain or to accurately represent useful problem-resolution information.

Using a retained segment to determine a set of putative steps could include using each retained segment as a respective different putative step, or could include additional or alternative steps. For example, retained segments that are contiguous within an incident report could be ‘collapsed’ into a single putative step so long as the segments were sufficiently similar (e.g., with respect to paragraph vectors determined for the segments).

Once a set of putative steps have been determined for a number of incident reports, the steps can be clustered to generate playbook steps. FIG. 7B illustrates putative steps from three different example first, second, and third incident reports “CS123456,” “CS234234 and “CS235674,” respectively. The putative steps from each of the incident reports are shown on different rows, while the three leftmost columns indicate membership within the three different incident reports. Note that the putative steps are not shown in the same order that they appeared in their incident reports (e.g., the numbered steps of incident report CS234234 are listed out of order). Instead, the ordering shown in FIG. 7B is the result of a sequencing operation performed subsequent to clustering the putative steps into playbook steps.

The set of putative steps from each incident report are clustered to identify playbook steps. Each row in FIG. 7B represents a respective playbook step and the cluster of putative steps corresponding thereto. So, for example, the first row represents a first playbook step that is related to a cluster of two putative steps (“Description: After activating . . . ” from the first incident report and “Description: Users are not able . . . ” from the second incident report). The third row represents another playbook steps that is related to a cluster of only one putative step (“2. Enter username and password” from the second incident report). The sixth row represents yet another playbook step that is related to a cluster of three putative steps, one from each of the incident reports (“Most Probably Cause: . . . ” from the first incident report, “2. Shows that our ldap server is not operational” from the second incident report, and “Description: we added a new LDAP server . . . ” from the third incident report).

Clustering the putative steps from a number of incident reports can include applying a number of processes. Such clustering could be performed based on the semantic content of the putative steps. For example, a paragraph vector could be determined for each of the putative steps and the putative steps could be clustered based on the paragraph vectors and/or other factors (e.g., the identity of the incident report containing the putative steps, proximity to other putative steps within an incident report, an identity of a section in which the putative step was identified, etc.). Clustering based on paragraph vectors or other factors related to the putative steps could be performed by applying a similarity metric, a k-means clustering algorithm, a support vector machine, a self-organizing map, or some other clustering method.

Note that the clusters of putative steps shown in FIG. 7B only contain at most one putative step from each incident report. This is intended as a non-limiting example embodiment for purposes of illustration. In practice, two or more putative steps from a single incident report could be clustered together to generate a playbook step. Such two or more steps from a single incident report could be neighboring and/or contiguous within the incident report or could be located at a variety of different locations within the incident report.

FIG. 7B also illustrates a representative name for each playbook step/cluster of putative steps. For example, the cluster of steps that includes “Description: After activating our LDAP connection, we are unable to log in to our development instance” and “Description: Users are not able to log into our DEV instance” is represented by the summary sentence “unable to login instance.” When presenting an indication of a generated playbook to a user (e.g., as a list of steps, as part of a knowledgebase article, as part of a user interface to permit the user to modify, approve, disapprove, or otherwise interact with a generated playbook), the playbook steps could be represented by such summary sentences. The summary sentences could be generated by a variety of methods, e.g., by methods described below. Alternatively, one of the putative steps corresponding to the playbook step could be selected (e.g., randomly) to represent the playbook step.

A ‘high quality’ playbook step represents an action that is likely to be helpful in resolving a particular problem or performing some process of interest. Accordingly, the action represented is likely to correspond to putative steps in many or all of the incident reports that have been used to generate the playbook step. Thus, a playbook generation process may include filtering out playbook steps that are ‘low quality.’ This can include determining a step quality score for each of the playbook steps and removing from the set of playbook steps any playbook steps whose step quality scores exceed a specified threshold (e.g., removing steps whose step quality scores are greater than a specified threshold in examples where lower step quality scores indicate higher-quality steps). Determining a step quality score for a playbook step can include determining how many incident reports contain putative steps that correspond to the playbook step. The specified threshold can be set such that playbook steps are filtered out if they are associated with putative steps from fewer than a threshold number or proportion of the incident reports used to generate the playbook.

Once the playbook steps have been generated and optionally filtered to remove low-quality playbook steps, a sequence can be determined for the set of playbook steps. The playbook steps (and corresponding clusters of putative steps) shown in FIG. 7B have already been sequenced and are displayed in the order of the sequence. The sequence can be determined based on the arrangement of the putative steps within their respective incident reports and based on the clustering of the putative steps into the determined playbook steps. The sequence can be determined such that the playbook steps are approximately in the order that they tend to appear in the incident reports used to generate the playbook steps. In practice this can lead to the putative steps having a sequence within a particular incident report that differs from the ordering of the playbook steps to which the putative steps correspond (e.g., as the numbered putative steps of the second incident in FIG. 7B are presented out of numerical order). Determining such a sequence can include applying methods used to determine the sequencing and alignment of DNA or RNA read fragments, e.g., the Needleman-Wunsch algorithm. This algorithm takes as input two similar incident reports that have had the low-quality putative steps removed and determines the sequence of the combined remaining putative steps between the two incident reports. The result can be a playbook or the result can be compared with additional incident reports to include addition putative steps.

The generated playbook steps can be displayed to a user according to the determined sequence. This can include representing each playbook step by a corresponding summary sentence. This is illustrated by way of example in FIG. 7C, which depicts elements of a user interface that a user can use to interact with a generated set of playbook steps. Such interactions could include modifying the set of playbook steps to comport with the user's intuition or expectation of a proper set of steps for the resolution of a problem or performing some other action related to a managed network. Interaction with the set of playbook steps could include editing the summary sentences, e.g., by clicking the displayed summary sentences and then operating a keyboard or other text input device to modify the summary sentence text. Interaction with the set of playbook steps could include re-ordering the playbook steps, e.g., by clicking and dragging the steps, by clicking and indication of the numerical ordering of a step and inputting an alternative numeral, or by some other interaction. Interaction with the set of playbook steps could include deleting one or more of the playbook steps. This could include clicking a button or other user interface element (e.g., the appropriate row within the “Accept in Playbook” column of the user interface depicted in FIG. 7C) to indicate that the step(s) should be removed from the set of playbook steps. Interaction with the set of playbook steps could include rejecting the set of playbook steps entirely, e.g., because the set of playbook steps does not represent a useful set of steps for resolving an identifiable problem or for performing some other identifiable action related to a managed network.

A user interface providing an indication of a set of playbook steps could also provide functionality for additional interaction with and/or application of a set of playbook steps. For example, such a user interface could facilitate a user generating a knowledgebase article from the set of playbook steps by, e.g., providing a text editor, means for specifying metadata for a knowledgebase article, information about related knowledgebase articles and the ability to specify links thereto, or other functionality. In another example, such a user interface could facilitate a user generating tools for a technician to implement one or more of the listed playbook steps and/or tools to automate one or more of the playbook steps. This could include providing statistics related to the playbook steps (e.g., an incidence of incident reports similar to those underlying the set of playbook steps), providing the text of putative steps or other information underlying the set of playbook steps, providing information about hardware or software that is related to the playbook steps (e.g., information about software or hardware versions or configurations that are related to the incident reports underlying the set of playbook steps), or providing some other functionality.

To provide additional benefits, generated sets of playbook steps may be filtered as a whole to avoid presenting human technicians with low-quality playbook, thereby avoiding the waste of expensive and limited technician time and effort. This can include determining a playbook quality score for the set of playbook steps and only presenting the set of playbook steps responsive to determining that the playbook quality score exceeds a specified threshold. For example, displaying a set of playbook steps whose playbook quality score is less than a specified threshold in examples where lower step quality scores indicate higher-quality playbooks. Determining a playbook quality score for a set of playbook steps can include determining how many (or what proportion) of the playbook steps of the set of playbook steps are represented in all, or substantially all, of the incident reports used to generate the set of playbook steps. A higher quality playbook will have more playbook steps that appear in all or substantially all of the of the incident reports used to generate the set of playbook steps.

Generating a playbook quality score can include determining a proportion of the playbook steps that are represented in more than a threshold number of the target set of incident reports. The threshold number could be an absolute value, or could be determined based on the number of incident reports underlying the set of playbook steps (e.g., a number determined by determining a fraction of the number in underlying incident reports and then rounding upward or downward to the nearest whole number).

Additionally or alternatively, generating a playbook quality score can include determining a difference between i) a number of the playbook steps and a maximum number of the playbook steps that are represented in a single incident report of the target set of incident reports, and ii) a difference between a sum of the numbers of the playbook steps that are represented in each individual incident report of the target set of incident reports and a maximum number of the playbook steps that are represented in a single incident report of the target set of incident reports. This can include determining a playbook quality score according to the formula:

$$SCORE = 1 - \frac{N - {max}_{i ∈ 1 : M} ( {n}_{i} )}{{\sum }_{i = 1}^{M} {n}_{i} - {max}_{i ∈ 1 : M} ( {n}_{i} )}$$

Where N is the total number of playbook steps, n, is the number of playbook steps associated with putative steps from incident report i, and M is the number of underlying incident reports used to generate the set of playbook steps.

### VII. EXAMPLE GENERATION OF REPRESENTATIVE NAMES FOR PLAYBOOK STEPS

When presenting an indication of a generated playbook to a user, the playbook steps could be represented by summary sentences (e.g., as shown in the example of FIG. 7C). Such summary sentences can be generated using a variety of methods, including but not limited to ML and/or semantic analysis techniques such as clustering, term frequency, word embedding, paragraph embedding, and potentially other techniques.

For example, once a cluster of putative steps has been identified, common word stems from the putative steps therein can be used to generate a representative name for the cluster (and also for the playbook step corresponding thereto) that is indicative of the content of these putative steps. Such a representative name may permit an IT professional to quickly and easily assess what a playbook step is “about,” e.g., what similarities exist between the putative steps within the cluster that resulted in their being assigned to the same cluster/playbook step. Without this contextual information, it may be more difficult for the IT professional to determine which playbook steps are relevant to resolving a particular problem that is related to a generated set of playbook steps, what problem or other discrete event a set of playbook steps is related to, whether the playbook steps of a playbook are in an appropriate order or if they should be re-ordered, whether the set of playbook steps as a whole represents a useful solution to a particular problem, or how to use the clusters of putative steps to positive effect according to some other application.

The information used to define the clusters of putative steps can be difficult or impossible for a human to parse in order to determine the semantic content of putative steps grouped within the cluster. For example, if the cluster is defined by neural network parameters, centroids or information defining a region in a p-dimensional semantic space, or other information that is not “human-understandable,” this defining information may not be helpful in providing an IT professional with the context of the cluster's content. While the IT professional could review some or all of the putative steps in the cluster to gain an understanding of the cluster, such a process can be very time-intensive, as the cluster may include many putative steps and/or the included putative steps may be difficult to read and understand (e.g., due to including segments of text that has been partitioned into sub-sentence fragments).

To address these issues, embodiments described herein provide mechanisms for determining, based on the putative steps assigned to a cluster, a string of words that describes the cluster and that can provide an IT professional with an understanding of the semantic content of putative steps within the cluster. This descriptive information is determined based on the text contained within the putative steps. It can be difficult to extract such meaning from the text of putative steps, as the putative steps may contain a variety of extraneous textual data (common parts of speech, names, punctuation, whitespace). Additionally, misspellings, different tenses or forms of the same word (e.g., email, emails, emailing, emailed) that represent the same contextual information, or other factors related to the textual information can make it difficult to estimate the informational content of the putative steps without under-representing or over-representing certain words.

The embodiments described herein compensate for these and other factors to generate descriptive strings for clusters of putative steps. While focused on putative steps, these embodiments could be used to generate such strings from the text of other types of records.

The corpus of text within the cluster of putative steps can first be transformed. This can include removing stop words, punctuation, and other irrelevant or otherwise unwanted contents of the corpus of text. Doing so could further include removing redundant whitespace, removing proper names, removing numbers, or removing some other contents. Letters in the corpus of text could also be converted into lowercase to avoid confounding subsequent analyses by the presence of words that would be the same but for differences in capitalization. A process could be applied to the corpus of text to convert acronyms and/or initials into a specified format, e.g., converting L.L.C. to llc, d/b/a to dba, S C U B A to scuba, etc. In some examples, misspellings or other errors in the corpus of text could be detected and corrected.

The remaining contents of the corpus of text could then be modified to map the words of the corpus to their word stems. For example, the words “email,” “emails,” “emailed,” and “emailing” could all be mapped to the word stem “email.” This mapping of words to word stems can be performed in order to equalize the representation of the informational content underlying the words present in the corpus of text such that concepts are not over- or under-represented in subsequent analysis due to the number of ways (e.g., word forms) by which the concepts are represented. Mapping words to word stems could be limited to mapping different tenses/forms of a single word. Alternatively, mapping word to word stems could be expanded by mapping synonyms or other words with similar meaning to a single stem word. For example, the words “microcontroller,” “microcontrollers,” “microcontroller(s),” “processor,” “processors,” “processor(s),” “microprocessor,” “microprocessors,” and “microprocessor(s)” could all be mapped to the word stem “processor.”

Mapping words in the corpus of text into word stems could include a variety of processes. For example, known suffixes, like ‘s,’ ‘es,’ ‘ed,’ ‘ing,’ ‘and ‘ly’ could be removed from the words in the corpus of text. Additionally or alternatively, a dictionary of mappings between words and word stems could be applied to map the words in the corpus of text to respective word stems. Such a dictionary-based approach could facilitate more complex mappings, such as mapping misspelled words to the word stem of the correctly-spelled word or mapping synonyms to a common word stem.

The most frequent word stems could then be determined. For example a subset of n word stems (e.g., the n most frequently-appearing word stems) from the corpus of text within the cluster of putative steps could be determined. The number, n, of determined word stems could be a small number, e.g., between one and five inclusive. Further, this number could be predetermined, or could be determined based on the word stems in the corpus of text. For example, n could be determined such that the word stems represent at least a specified fraction of the words in the corpus of words, represent words present in at least a specified fraction of the putative steps in the cluster, or such that some other consideration is satisfied.

The n determined word stems could be determined in a variety of ways. For example, the n determined word stems could be the n most common word stems in the mapped corpus of text. In another example, a TF-IDF value or some other normalized term frequency value could be determined for each of the word stems and the determined TF-IDF values could be used to determine the n word stems having the highest TF-IDF values. In some examples, a combination of different factors could be used to determine the n word stems. For example, a weighted combination of the absolute frequency and the TF-IDF of the word stems could be used.

The n word stems can then be converted into n words that will form part of a textual description (name) for the playbook step to which the cluster of putative steps corresponds. Converting the word stems into respective words could include mapping each word stem to a respective default word (e.g., using a dictionary). Such a default word could be the shortest word, with respect to number of letters, number of syllables, etc., that is present in the dictionary as being mapped to the particular word stem. Alternatively, the word stem could be mapped to the shortest word (with respect to number of letters, number of syllables, etc.) that was present in the corpus of text and that was mapped to the word stem. For example, if the words “email,” “emails,” “emailed,” and “emailing” map to the word stem “email”, then the word “email” may be chosen as the shortest word that maps to this word stem.

The n words can then be applied to provide a representative textual description for the playbook step generated from the cluster of putative steps. This can include providing the n words on a display, e.g., in combination with a representation of the playbook step, a link to the playbook and/or contents thereof (e.g., a listing of the contents of the putative steps, their correspondence to one or more incident reports, etc.), a button or other user interface element for accessing, modifying, or otherwise interacting with the playbook step, or some other user interface elements.

A user could be presented with a user interface to permit the user to review, edit, and/or approve the set of n words. Upon approval, an indication of the n words (or edited versions thereof) could be stored in a database with the playbook step that they describe as the name of that cluster.

### VIII. EXAMPLE OPERATIONS

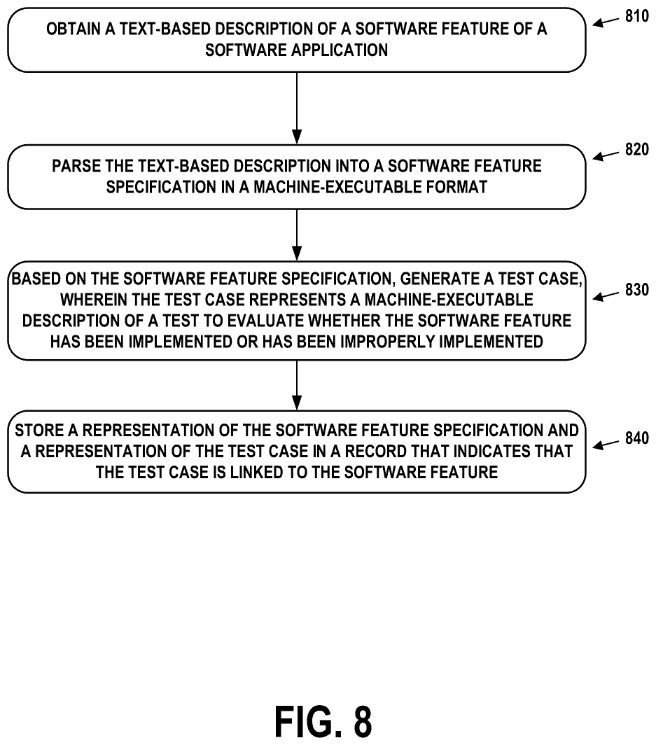

FIG. 8 is a flow chart illustrating an example embodiment. The process illustrated by FIG. 8 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 8 may be simplified by the removal of any one or more of the features shown therein. Further, these embodiments may be combined with features, aspects, and/or implementations of any of the previous figures or otherwise described herein.

At block 810, the process illustrated by FIG. 8 includes determining, from a target set of incident reports, a set of putative steps, wherein each incident report of the target set of incident reports includes at least one putative step from the set of putative steps.

Determining the set of putative steps from the target set of incident reports can additionally include discarding segments having tags that correspond to a specified set of one or more reject tags.

Determining the set of putative steps from the target set of incident reports can include: (i) identifying a set of non-overlapping segments within each incident report of the target set of incident reports, (ii) determining a score for each of the identified segments, and (iii) determining the set of putative steps based on segments whose scores exceed a specified threshold. Determining a score for each of the identified segments can include determining the score based on at least one of: whether a segment contains an action verb, the number of action verbs in the segment, whether the segment contains a configuration item or artifact, whether the segment contains a list, whether the segment contains a question, whether the segment represents boilerplate content, whether the segment contains a uniform resource location (URL), a number of words in the segment, whether the segment contains words indicative of proposing a solution, or whether the segment contains or ends with a colon. Identifying a set of non-overlapping segments within each incident report of the target set of incident reports can include at least one of: breaking text of the incident reports into sentences or clauses, generating the segments such that ending punctuation is placed at ends of segments, or generating the segments such that some of the segments correspond to elements of bulleted or numbered lists

At block 820, the process illustrated by FIG. 8 also includes determining a set of playbook steps by identifying a set of clusters within the set of putative steps, wherein each playbook step of the set of playbook steps corresponds to a respective cluster within the identified set of clusters, and wherein each cluster within the identified set of clusters contains at least one putative step of the set of putative steps.

Identifying a set of clusters within the set of putative steps can include determining, for each of the putative steps, a respective paragraph vector that projects text within each of the putative steps into an m-dimensional semantic feature space.

At block 830, the process illustrated by FIG. 8 yet further includes determining a sequence for the set of playbook steps based on an ordering of the putative steps within the target set of incident reports and the correspondences between the putative steps and the identified set of clusters.

At block 840, the process illustrated by FIG. 8 additionally includes displaying, on a user interface, an indication of the set of playbook steps according to the determined sequence for the set of playbook steps.

The process illustrated by FIG. 8 could include additional steps or elements. For example, the process illustrated by FIG. 8 could additionally include, based on the putative steps, determining a representative name for each of the playbook steps in the set of playbook steps, wherein displaying the indication of the set of playbook steps according to the determined sequence for the set of playbook steps comprises representing each playbook step by its corresponding representative name.

In another example, the process illustrated by FIG. 8 could additionally include determining, for each playbook step in the set of playbook steps, a step quality score; and, prior to displaying the indication of the set of playbook steps according to the determined sequence for the set of playbook steps, removing from the set of playbook steps one or more of the playbook steps whose step quality score exceeds a specified threshold.

In yet another example, the process illustrated by FIG. 8 could additionally include determining, based on the set of playbook steps, a playbook quality score; in such an embodiment, displaying the indication of the set of playbook steps according to the determined sequence for the set of playbook steps can be performed responsive to determining that the playbook quality score exceeds a specified threshold. Determining the playbook quality score can include determining a ratio between i) a difference between a number of the playbook steps and a maximum number of the playbook steps that are represented in a single incident report of the target set of incident reports, and ii) a difference between a sum of the numbers of the playbook steps that are represented in each individual incident report of the target set of incident reports and a maximum number of the playbook steps that are represented in a single incident report of the target set of incident reports. Determining the playbook quality score can additionally or alternatively include determining a proportion of the playbook steps that are represented in more than a threshold number of the target set of incident reports.

In still another example, the process illustrated by FIG. 8 could additionally include selecting the target set of incident reports from a database of incident reports. Selecting the target set of incident reports from the database of incident reports can include determining a step extraction score for an incident in the database of incident reports. Determining the step extraction score for the incident in the database of incident reports can include determining at least one of: a number of action verbs in the incident report, whether the incident report contains a configuration item or artifact, whether the incident report contains a list, or a number of words in the incident report. Selecting the target set of incident reports from the database of incident reports can include identifying a group of similar incident reports within the database of incident reports. Identifying the group of similar incident reports within the database of incident reports can include determining similarity metrics for the incident reports within the database of incident reports and selecting a set of n incident reports within the database of incident reports having the highest similarity metrics.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. An article of manufacture including a non-transitory computer-readable medium, having stored thereon program instructions that, upon execution by one or more processors of a computing system, cause the computing system to perform operations comprising:
determining, from a set of entries stored in a memory, a set of performed actions, wherein each of the entries includes at least one of the performed actions, wherein at least one of the entries includes at least two of the performed actions, and wherein the entries represent events that occurred on a computing device or network;
based on textual content relating to the performed actions, discarding, from the set, at least some of the performed actions that have less than a threshold relevance to the events that occurred on the computing device or network, wherein discarding at least some of the performed actions from the set comprises discarding, from the set, at least one performed action from a particular entry of the set of entries and retaining, in the set, at least one performed action from the particular entry;
generating multidimensional vector embeddings of the performed actions by applying textual content relating to each of the performed actions to a machine learning model that has been trained to determine contextual meanings of multi-word text samples using a plurality of paragraphs of text;
subsequent to discarding at least some of the performed actions that have less than the threshold relevance from the set, identifying clusters of similar actions within the set of performed actions based on the multidimensional vector embeddings of the performed actions, wherein each of the performed actions is a member of one of the clusters, and wherein each of the clusters contains at least one of the performed actions;
determining a sequence for the clusters based on orderings of the performed actions within the set of entries and the membership of the performed actions within the clusters; and
providing for display, on a user interface, representations of the performed actions within the clusters, wherein the representations of the performed actions are ordered according to the sequence for the clusters.

2. The article of manufacture of claim 1, wherein the multidimensional vector embeddings of the performed actions represent the performed actions in an m-dimensional semantic feature space, and wherein identifying the clusters of similar actions within the set of performed actions comprises determining, for each of the performed actions, a respective paragraph vector that projects text within each of the performed actions into the m-dimensional semantic feature space.

3. The article of manufacture of claim 1, wherein the operations further comprise:
based on the performed actions, determining a representative name for each of the clusters, wherein providing for display the representations of the performed actions within the clusters according to the sequence for the clusters comprises representing each cluster by its corresponding representative name.

4. The article of manufacture of claim 1, wherein discarding, from the set, at least some of the performed actions that have less than the threshold relevance to the events that occurred on the computing device or network comprises (i) identifying a set of non-overlapping segments within each entry, thereby determining the set of performed actions, (ii) determining a score for each of the performed actions, and (iii) discarding, from the set, performed actions whose scores do not exceed a specified threshold.

5. The article of manufacture of claim 4, wherein determining the score for each of the identified performed actions comprises determining the score based on at least one of: whether a performed action contains an action verb, a number of action verbs in the performed action, whether the performed action contains a configuration item or artifact, whether the performed action contains a list, whether the performed action contains a question, whether the performed action represents boilerplate content, whether the performed action contains a uniform resource locator (URL), a number of words in the performed action, whether the performed action contains words indicative of proposing a solution, or whether the performed action contains or ends with a colon.

6. The article of manufacture of claim 4, wherein identifying the set of non-overlapping segments within each entry comprises at least one of: breaking text of the entries into sentences or clauses, generating the performed actions such that ending punctuation is placed at ends of performed actions, or generating the performed actions such that some of the performed actions correspond to elements of bulleted or numbered lists.

7. The article of manufacture of claim 4, wherein determining the set of performed actions from the entries further comprises discarding performed actions having tags that correspond to a specified set of one or more reject tags.

8. The article of manufacture of claim 1, wherein the operations further comprise:
determining, for each cluster, a cluster quality score; and
prior to providing representations of the performed actions within the clusters for display, removing from the set of clusters one or more of the clusters whose cluster quality score does not exceed a specified threshold.

9. The article of manufacture of claim 1, wherein the operations further comprise:
determining, based on the set of clusters, a sequence quality score, wherein providing representations of the performed actions within the clusters for display ordered according to the determined sequence for the clusters is performed responsive to determining that the sequence quality score exceeds a specified threshold.

10. The article of manufacture of claim 9, wherein determining the sequence quality score comprises determining a ratio between (i) a difference between a number of the clusters and a maximum number of the clusters that are represented in a single entry stored in the memory, and (ii) a difference between a sum of the numbers of the clusters that are represented in each individual entry stored in the memory and a maximum number of the clusters that are represented in a single entry stored in the memory.

11. The article of manufacture of claim 9, wherein determining the sequence quality score comprises determining a proportion of the clusters that are represented in more than a threshold number of the entries.

12. The article of manufacture of claim 1, wherein the operations further comprise:
selecting the set of entries from a database of entries stored in the memory.

13. The article of manufacture of claim 12, wherein selecting the set of entries from the database of entries comprises determining an action extraction score for an entry in the database of entries.

14. The article of manufacture of claim 13, wherein determining the action extraction score for the entry in the database of entries comprises determining at least one of: a number of action verbs in the entry, whether the entry contains a configuration item or artifact, whether the entry contains a list, or a number of words in the entry.

15. The article of manufacture of claim 12, wherein selecting the set of entries from the database of entries comprises identifying a group of similar entries within the database of entries.

16. The article of manufacture of claim 15, wherein identifying the group of similar entries within the database of entries comprises determining similarity metrics for entries within the database of entries and selecting a set of n entries within the database of entries having the highest similarity metrics.

17. A computational instance of a remote network management platform comprising:
a database containing a plurality of entries stored in a memory, wherein the entries include text-based fields that document technology-related problems experienced by users of a managed network; and
one or more processors configured to:
determine, from a set of entries contained within the database, a set of performed actions, wherein each of the entries includes at least one of the performed actions, wherein at least one of the entries includes at least two of the performed actions, and wherein the entries represent events that occurred on a computing device or network;
based on textual content relating to the performed actions, discard, from the set, at least some of the performed actions that have less than a threshold relevance to the events that occurred on the computing device or network, wherein discarding at least some of the performed actions from the set comprises discarding, from the set, at least one performed action from a particular entry of the set of entries and retaining, in the set, at least one performed action from the particular entry;
generating multidimensional vector embeddings of the performed actions by applying textual content relating to each of the performed actions to a machine learning model that has been trained to determine contextual meanings of multi-word text samples using a plurality of paragraphs of text;
identify a set of clusters of similar actions within the set of performed actions based on the multidimensional vector embeddings of the performed actions, wherein each of the performed actions is a member of one of the clusters, and wherein each of the clusters contains at least of the performed actions;
determine a sequence for the clusters based on orderings of the performed actions within the set of entries and the membership of the performed actions within the clusters; and
provide for display, on a user interface, representations of the performed actions within the clusters, wherein the representations of the performed actions are ordered according to the sequence for the clusters.

18. The computational instance of claim 17, wherein the one or more processors are also configured to:
select the set of entries from the database of entries by identifying a group of similar entries that are contained within the database.

19. A computer-implemented method comprising:
determining, from a set of entries stored in a memory, a set of performed actions, wherein each of the entries includes at least one of the performed actions, wherein at least one of the entries includes at least two of the performed actions, and wherein the entries represent events that occurred on a computing device or network;
based on textual content relating to the performed actions, discarding, from the set, at least some of the performed actions that have less than a threshold relevance to the events that occurred on the computing device or network, wherein discarding at least some of the performed actions from the set comprises discarding, from the set, at least one performed action from a particular entry of the set of entries and retaining, in the set, at least one performed action from the particular entry;
generating multidimensional vector embeddings of the performed actions by applying textual content relating to each of the performed actions to a machine learning model that has been trained to determine contextual meanings of multi-word text samples using a plurality of paragraphs of text;
identifying clusters of similar actions within the set of performed actions based on the multidimensional vector embeddings of the performed actions, wherein each of the performed actions is a member of one of the clusters, and wherein each of the clusters contains at least one of the performed actions;
determining a sequence for the clusters based on orderings of the performed actions within the set of entries and the membership of the performed actions within the clusters; and
providing for display, on a user interface, representations of the performed actions within the clusters, wherein the representations of the performed actions are ordered according to the determined sequence for the clusters.

20. The computer-implemented method of claim 19, further comprising:
selecting the set of entries from a database of entries by identifying a group of similar entries that are contained within the database.
